(19) United States
(12) Patent Application Publication
(10) Pub. No.: US 2013/0346552 A1
(43) Pub. Date: Dec. 26, 2013

(54) DOWNLOAD METHOD, SYSTEM, AND DEVICE FOR MOBILE TERMINAL

(71) Applicant: TENCENT TECHNOLOGY (SHENZHEN) COMPANY LIMITED, Shenzhen City (CN)

(72) Inventor: Ning Yu, Shenzhen City (CN)

(73) Assignee: TENCENT TECHNOLOGY (SHENZHEN) COMPANY LIMITED, Shenzhen City (CN)

(21) Appl. No.: 13/974,572

(22) Filed: Aug. 23, 2013

Related U.S. Application Data
(63) Continuation of application No. PCT/CN2011/084720, filed on Dec. 27, 2011.

(30) Foreign Application Priority Data
Feb. 24, 2011 (CN) 201110045443.9

(51) Int. Cl. H04L 29/08

(52) U.S. Cl. CPC H04L 67/06
USPC 709/217

(57) ABSTRACT

The present invention, pertaining to the field of communications technologies, discloses a method, system and device for a mobile terminal. The method includes: receiving a download request from a mobile terminal, and judging whether local information includes backup server information of a resource indicated in the download request; and if the local information includes the backup server information of the resource indicated in the download request, sending the backup server information to the mobile terminal such that the mobile terminal downloads the resource according to the backup server information. The proxy download server includes: a receiving module, a judging module, and a sending module. The mobile terminal includes a sending module and a download module. The present invention improves the download speed and bandwidth usage rate of the mobile terminal browser, and enhances the performance of the mobile terminal browser and the performance of the mobile terminal.

### FIELD OF THE INVENTION

The present invention relates to the field of communications technologies, and in particular, to a download method, system, and device for a mobile terminal, i.e., a mobile terminal and a proxy download server.

### BACKGROUND OF THE INVENTION

With increase of the network access speed and decrease in fees and tariff, mobile phones are not only widely used for web browsing web but also widely used for downloading resources. By using mobile terminal browsers, users can download pictures, audios, and videos. Currently, mobile terminal browsers directly establish HTTP connections with an original server to download data according to relevant standards and protocols.

After analysis on the prior art, the inventor finds that the prior art has at least the following disadvantages:

In the mobile phone network, the egress rate of the server is limited, resulting in a low download speed in the case of direct connection between the mobile phone and the server. In addition, once the mobile terminal browser has too many download tasks, a large amount of bandwidth is occupied. As a result, the performance of the mobile terminal browser and the performance of the mobile phone deteriorate.

### SUMMARY OF THE INVENTION

Embodiments of the present invention provide a download method, system and device for a mobile terminal The technical solutions are as follows: A download method for a mobile terminal is provided, where the method includes:

receiving a download request from a mobile terminal, and judging whether local information includes backup server information of a resource indicated in the download request; and if the local information includes the backup server information of the resource indicated in the download request, sending the backup server information to the mobile terminal such that the mobile terminal downloads the resource according to the backup server information.

The judging whether local information includes backup server information of a resource indicated in the download request specifically includes:

querying in a locally stored peer-to-peer resource list and judging whether the locally stored peer-to-peer resource list includes the resource indicated in the download request and the address of the backup server where the resource is stored; where if true, the local information includes the backup server information of the resource indicated in the download request, and otherwise, the local information does not include the backup server information of the resource indicated in the download request.

The method further includes:

storing a resource whose download frequency within a predetermined duration exceeds a first predetermined threshold to a resource cache server, and storing a mapping relationship between the resource whose download frequency within the predetermined duration exceeds the first predetermined threshold and the resource cache server.

The method further includes:

when resources stored in a resource cache server exceed a second predetermined threshold, deleting a least frequently downloaded resource from the resources.

A download method for a mobile terminal is provided, where the method includes:

sending a download request to a proxy download server; and

receiving backup server information from the proxy download server, and downloading a resource indicated in the download request from a backup server corresponding to the backup server information, where the backup server is a server where the resource indicated in the download request is stored.

After the sending a download request to a proxy download server, the method further includes:

when no backup server information is received from the proxy download server within the predetermined duration, judging whether a resource cache server stores the resource indicated in the download request; if true, downloading the resource indicated in the download request from the resource cache server, and otherwise, downloading the resource indicated in the download request from the original server.

The downloading a resource indicated in the download request from a backup server corresponding to the backup server information specifically includes:

sending a fragmentation request to the original server and the backup server corresponding to the backup server information, and downloading fragments of the resource indicated in the download request from the original server and the backup server corresponding to the backup server information.

The method further includes:

when download is interrupted before the resource is completely downloaded, sending a breakpoint resume transmission request to the original server, the resource cache server, or the backup server corresponding to the backup server information.

Prior to the sending a download request to a proxy download server, the method further includes:

sending a download request to an original server, and receiving a response packet header from the original server, where the response packet header is of a non-web page file resource type.

A proxy download server is provided, where the server includes:

a receiving module, configured to receive a download request from a mobile terminal, and trigger a judging module to judge whether local information includes backup server information of a resource indicated in the download request; and

a sending module, configured to, if the local information includes the backup server information of the resource indicated in the download request, send the backup server information to the mobile terminal such that the mobile terminal downloads the resource according to the backup server information.

The judging module includes:

a querying unit, configured to query in a locally stored peer-to-peer resource list and judge whether the locally stored peer-to-peer resource list includes the resource indicated in the download request and the address of the backup server where the resource is stored; where if true, the local information includes the backup server information of the resource indicated in the download request, and otherwise, the local information does not include the backup server information of the resource indicated in the download request.

The proxy download server further includes:

a cache module, configured to store a resource whose download frequency within a predetermined duration exceeds a first predetermined threshold to a resource cache server, and store a mapping relationship between the resource whose download frequency within the predetermined duration exceeds the first predetermined threshold and the resource cache server.

The proxy download server further includes:

a deleting module, configured to, when resources stored in a resource cache server exceed a second predetermined threshold, delete a least frequently downloaded resource from the resources.

A mobile terminal is provided, where the mobile terminal includes:

a sending module, configured to send a download request to a proxy download server; and

a download module, configured to receive backup server information from the proxy download server, and download a resource indicated in the download request from a backup server corresponding to the backup server information, where the backup server is a server where the resource indicated in the download request is stored.

The mobile terminal further includes:

a judging module, configured to: when no backup server information is received from the proxy download server within the predetermined duration, judge whether a resource cache server stores the resource indicated in the download request; if true, download the resource indicated in the download request from the resource cache server, and otherwise, download the resource indicated in the download request from the original server.

The download module includes:

a fragmenting unit, configured to send a fragmentation request to the original server and the backup server corresponding to the backup server information; and

a download unit, configured to download fragments of the resource indicated in the download request from the original server and the backup server corresponding to the backup server information.

The mobile terminal further includes:

a breakpoint resume transmission module, configured to, when download is interrupted before the resource is completely downloaded, send a breakpoint resume transmission request to the original server, the resource cache server, or the backup server corresponding to the backup server information.

The sending module is further configured to send a download request to an original server, and receive a response packet header from the original server, where the response packet header is of a non-web page file resource type.

A download system is provided, where the system includes: a mobile terminal and a proxy download server.

The mobile terminal is configured to send a download request to the proxy download server.

The proxy download server is configured to receive the download request from the mobile terminal, judge whether local information includes backup server information of a resource indicated in the download request, and if the local information includes the backup server information of the resource indicated in the download request, send the backup server information to the mobile terminal

The mobile terminal is further configured to receive backup server information from the proxy download server, and download the resource indicated in the download request from a backup server corresponding to the backup server information, where the backup server is a server where the resource indicated in the download request is stored.

The proxy download server includes:

a judging module, configured to query in a locally stored peer-to-peer resource list and judge whether the locally stored peer-to-peer resource list includes the resource indicated in the download request and the address of the backup server where the resource is stored; where if true, the local information includes the backup server information of the resource indicated in the download request, and otherwise, the local information does not include the backup server information of the resource indicated in the download request.

Furthermore, the proxy download server further includes:

a cache module, configured to store a resource whose download frequency within a predetermined duration exceeds a first predetermined threshold to a resource cache server, and store a mapping relationship between the resource whose download frequency within the predetermined duration exceeds the first predetermined threshold and the resource cache server.

Furthermore, the proxy download server further includes:

a deleting module, configured to, when resources stored in a resource cache server exceed a second predetermined threshold, delete a least frequently downloaded resource from the resources.

Furthermore, the mobile terminal further includes:

a judging module, configured to: when no backup server information is received from the proxy download server within the predetermined duration, judge whether a resource cache server stores the resource indicated in the download request; if true, download the resource indicated in the download request from the resource cache server, and otherwise, download the resource indicated in the download request from the original server.

Furthermore, the mobile terminal further includes:

a download module, configured to send a fragmentation request to the original server and the backup server corresponding to the backup server information, and download fragments of the resource indicated in the download request from the original server and the backup server corresponding to the backup server information.

Furthermore, the mobile terminal further includes:

a breakpoint resume transmission module, configured to, when download is interrupted before the resource is completely downloaded, send a breakpoint resume transmission request to the original server, the resource cache server, or the backup server corresponding to the backup server information.

Furthermore, the mobile terminal further includes:

a sending module, configured to send a download request to an original server, and receive a response packet header from the original server, where the response packet header is of a non-web page file resource type.

The technical solutions according to the embodiments of the present invention achieve the following beneficial effects:

During resource downloading of a mobile terminal, when a download request is received from the mobile terminal, server information is provided for the mobile terminal according to local information such that the mobile terminal is capable of downloading a resource or resources from a proxy download server or another server according to the server information. This improves the download speed and bandwidth usage rate of the mobile terminal browser, and enhances the performance of the mobile terminal browser and the performance of the mobile terminal.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and persons of ordinary skill in the art can derive other drawings from these accompanying drawings without creative efforts.

FIG. 1 is a flowchart of a download method for a mobile terminal according to an embodiment of the present invention;

FIG. 2 is a flowchart of a download method for a mobile terminal according to an embodiment of the present invention;

FIG. 3 is a flowchart of a download method for a mobile terminal according to an embodiment of the present invention;

FIG. 4 is a schematic structural diagram of a proxy download server according to an embodiment of the present invention;

FIG. 5 is a schematic structural diagram of a proxy download server according to an embodiment of the present invention;

FIG. 6 is a schematic structural diagram of a mobile terminal according to an embodiment of the present invention; and

FIG. 7 is a schematic structural diagram of a mobile terminal according to an embodiment of the present invention.

### DETAILED DESCRIPTION OF THE INVENTION

To make the objectives, technical solutions, and advantages of the present invention clearer, the embodiments of the present invention are described in detail below with reference to the accompanying drawings.

Prior to description of the download method for a mobile terminal provided in the present invention, basic knowledge involved in the present invention is briefly described as follows.

Mobile phone browser: a browser installed in a mobile phone for web browsing.

Breakpoint resume transmission: when a network failure occurs, users are allowed to continue their previously interrupted download tasks, instead of re-downloading.

Proxy download server: a transfer server for a client to download network resources.

Offline download: when the download speed from the original server is too low, the proxy download server firstly downloads resources for users, subsequently, users download the resources at a high speed therefrom.

Resource cache server: a server caches the resources downloaded from the original server, enabling users to download the resources in case of losing connection with the original server.

### Embodiment 1

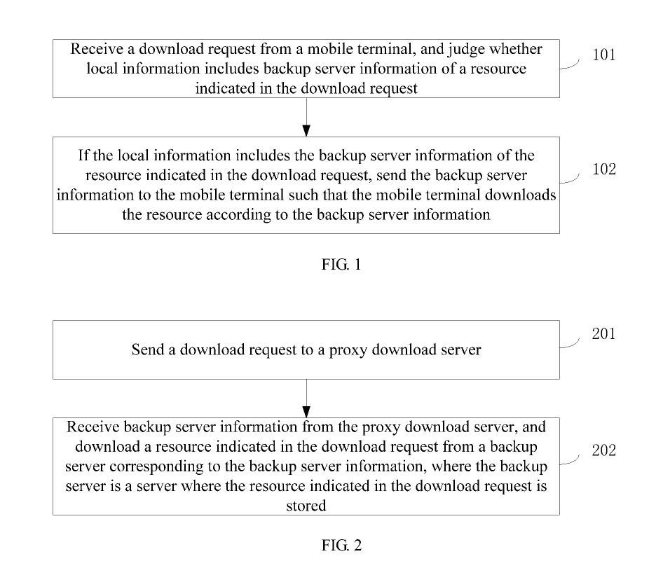

To improve the performance of a mobile terminal browser, an embodiment of the present invention provides a download method for a mobile terminal, which is performed by a proxy download server. Referring to FIG. 1, the download method includes the following steps:

101: receiving a download request from a mobile terminal, and judging whether local information includes backup server information of a resource indicated in the download request; and

102: if the local information includes the backup server information of the resource indicated in the download request, sending the backup server information to the mobile terminal such that the mobile terminal downloads the resource according to the backup server information.

The backup server information includes one or a plurality of types of server location-specific information such as the IP address, name, and MAC address of the server.

The step of “judging whether local information includes backup server information of a resource indicated in the download request” specifically includes:

querying in a locally stored peer-to-peer resource list and judging whether the locally stored peer-to-peer resource list includes the resource indicated in the download request and the address of the backup server where the resource is stored; where if true, the local information includes the backup server information of the resource indicated in the download request, and otherwise, the local information does not include the backup server information of the resource indicated in the download request.

Furthermore, the method further includes:

storing a resource whose download frequency within a predetermined duration exceeds a first predetermined threshold to a resource cache server, and storing a mapping relationship between the resource whose download frequency within the predetermined duration exceeds the first predetermined threshold and the resource cache server.

For example, assuming that the predetermined duration is 24 hours and the first predetermined threshold is 100, when a resource (for example, a segment of audio data) has been downloaded for over 100 times within 24 hours, the resource is stored in the resource cache server, and a mapping relationship between the resource and the resource cache server is stored. To be specific, a storage event is recorded such that, during a subsequent download process, it is acquired according to the storage event that the resource is stored in the resource cache server.

It should be noted that, the first predetermined threshold in this embodiment may be set by those skilled in the art by taking into consideration processing capabilities of the proxy download server and the resource cache server.

Furthermore, the method further includes:

when resources stored in a resource cache server exceed a second predetermined threshold, deleting a least frequently downloaded resource from the resources.

For example, assuming that the second predetermined threshold is 50 MB, then when over 50 MB resources are stored in the resource cache server, the processing speed of the resource cache server may be affected. In this case, the resources that are least frequently downloaded are deleted from the stored resources. Those skilled in the art may acknowledge that, during resource downloading, the resource cache server collects statistics for the times or frequency that a resource or resources are downloaded (or copied). Before deletion of the resources, the download times of the resources calculated are compared, and the resource or resources that are least downloaded are determined.

It should be noted that, the second predetermined threshold in this embodiment may be set by those skilled in the art according to processing capabilities of the resource cache server.

During resource downloading of a mobile terminal, when a download request from the mobile terminal is received, server information is provided for the mobile terminal according to local information such that the mobile terminal is capable of downloading a resource or resources from a proxy download server or another server according to the server information. This improves the download speed and bandwidth usage rate of the mobile terminal browser, and enhances the performance of the mobile terminal browser as well as the performance of the mobile terminal.

### Embodiment 2

To improve the performance of a mobile terminal browser, an embodiment of the present invention provides a download method for a mobile terminal, which is performed by a client. Preferably, the client may be a mobile phone browser. Referring to FIG. 2, the download method includes the following steps:

201: sending a download request to a proxy download server; and

202: receiving backup server information from the proxy download server, and downloading a resource indicated in the download request from a backup server corresponding to the backup server information, where the backup server is a server where the resource indicated in the download request is stored.

Furthermore, after the step of “sending a download request to a proxy download server”, the method further includes:

when no backup server information is received from the proxy download server within the predetermined duration, judging whether a resource cache server stores the resource indicated in the download request; if true, downloading the resource indicated in the download request from the resource cache server, otherwise, downloading the resource indicated in the download request from the original server.

Furthermore, the step of “downloading a resource indicated in the download request from a backup server corresponding to the backup server information” specifically includes:

sending a fragmentation request to the original server and the backup server corresponding to the backup server information, and downloading fragments of the resource indicated in the download request from the original server and the server corresponding to the server information. The server corresponding to the server information refers to the backup server corresponding to the backup server information.

Those skilled in the art may acknowledge that the principles for initiating fragmentation request by the mobile terminal and principles for subsequently processing fragmented data are the same as those of a personal computer, which are not described herein any further.

Furthermore, the method further includes:

when the downloading process is interrupted before the resource is completely downloaded, sending a breakpoint resume transmission request to the original server, the resource cache server, or the server corresponding to the server information. The server corresponding to the server information refers to the backup server corresponding to the backup server information.

Furthermore, prior to the step of “sending a download request to a proxy download server”, the method further includes:

Sending a download request to an original server, and receiving a response packet header from the original server, where the response packet header is of a non-web page file resource type.

During resource downloading of a mobile terminal, when a download request is received from the mobile terminal, server information is provided for the mobile terminal according to local information such that the mobile terminal is capable of downloading a resource or resources from a proxy download server or another server according to the server information. This improves the download speed and bandwidth usage rate of the mobile terminal browser, and enhances the performance of the mobile terminal browser and the performance of the mobile terminal

### Embodiment 3

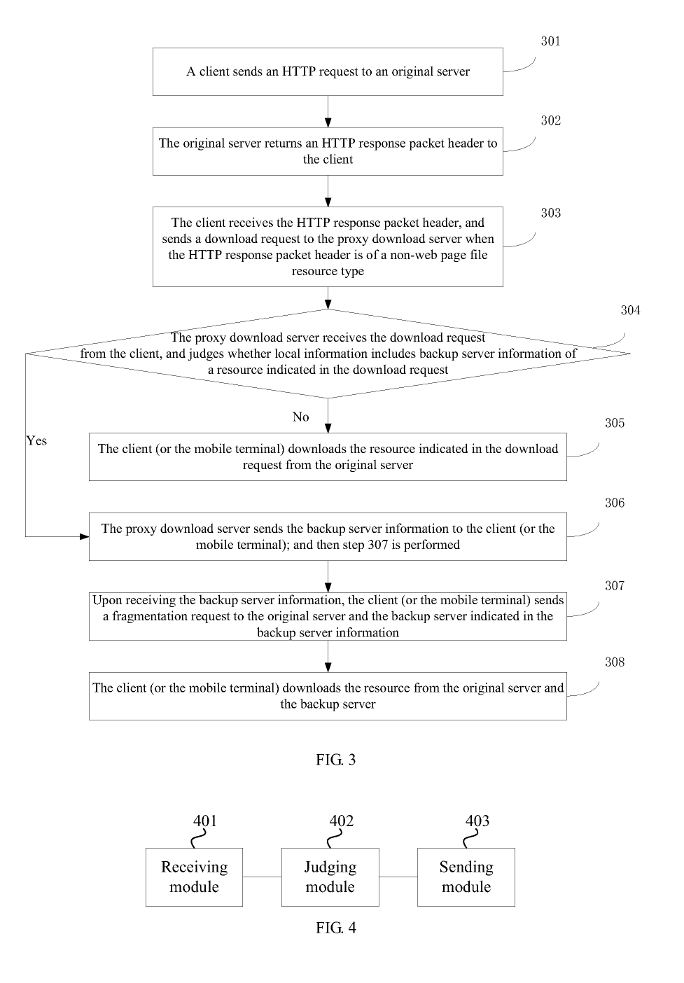

To improve the performance of a mobile terminal browser, an embodiment of the present invention provides a download method for a mobile terminal The client may be a mobile terminal browser. Referring to FIG. 3, the download method includes the following steps:

301: A client sends an HTTP request to an original server.

In this embodiment, the client browses a web page, and sends an HTTP request to the original server upon receiving a download request from a user.

302: The original server returns an HTTP response packet header to the client.

In this embodiment, the original server (that is, a web server) parses the HTTP request, locates a desired resource, and returns an HTTP response packet header to the client; the client parses the HTTP response packet header and acquires the type of the desired resource, where the resource may be of a non-web page file resource type or a web page file resource type.

303: The client receives the HTTP response packet header, and sends a download request to the proxy download server when the HTTP response packet header is of a non-web page file resource type.

304: The proxy download server receives the download request from the client (may also be a mobile terminal), and judges whether local information includes backup server information of a resource indicated in the download request.

If true, i.e., the local information includes the backup server information of the resource indicated in the download request, step 306 is performed.

Otherwise, i.e., the local information does not include the backup server information of the resource indicated in the download request, step 305 is performed.

In the embodiment of the present invention, during the resource downloading process, the proxy download server stores the backup server information. Preferably, the backup server information is a peer-to-peer resource node list, and includes resources and the servers where the resources are stored, i.e., a list of other backup servers where a resource is stored. This facilitates multi-connection offline download for users.

Specifically, in step 304, the step of judging whether local information includes backup server information of a resource indicated in the download request” specifically includes:

querying in a locally stored peer-to-peer resource list and judging whether the locally stored peer-to-peer resource list includes the resource indicated in the download request and the address of the backup server where the resource is stored; where if true, the local information includes the backup server information of the resource indicated in the download request, and otherwise, the local information does not include the backup server information of the resource indicated in the download request.

Those skilled in the art may acknowledge that the proxy download server can acquire the peer-to-peer resource node list by using the following methods:

1. acquiring a Hash value and a URL of each of the resource files in the network by using a crawler server.

2. reporting the Hash value and URL of a resource file by the client to the proxy download server.

In these two methods, one Hash value is equivalent to a keyword uniquely identifying a file, and the peer-to-peer node resource has the same Hash value and different URLs. In this way, a peer-to-peer resource node list is formed. Therefore, after a peer-to-peer resource node list is acquired, when a user downloads a file for a second time, the user can find all URLs of the peer-to-peer resource list according to the Hash value of the file.

According to the method provided in this embodiment, when an original web site encounters a temporary failure, users can still download their desired resource or resources. Meanwhile, to ensure synchronization of the resource or resources, the proxy server periodically updates its resource list.

In conclusion, step 304 is used to judge whether the resource or resources are stored in other servers, and return a list of these servers to the client for the client to choose.

In this embodiment, furthermore, the proxy download server still needs to check the validity of the download request, and in this case, step 304 may also be as follows: The proxy download server receives a download request from the client (may also be a mobile terminal), and checks validity of the download request; when the download request is authorized, i.e., the client initiating the download request is an authorized user or the resource indicated in the download request is an authorized resource, the proxy download server judges whether the local information includes the backup server information of the resource indicated in the download request; and when the download request is not authorized, the proxy download server denies the request, and ends the process. A mobile terminal browser generally encrypts the URL in the download request sent to the proxy download server. This ensures that the proxy download server is free of attacks from other unauthorized requests.

305: The client (or the mobile terminal) downloads the resource indicated in the download request from the original server; and then the process ends.

Those skilled in the art may acknowledge that when the proxy download server does not store the resource and the information of the backup server where the resource is stored, the client (or the mobile terminal) downloads the resource from the original server.

306: The proxy download server sends the backup server information to the client (or the mobile terminal); and then step 307 is performed.

In the embodiments of the present invention, the proxy download server caches a resource or resources that are more frequently downloaded by users within a recent period of time. To be specific, the resource or resources may be cached in a resource cache server designated by the proxy download server, or may be cached in the proxy download server.

Furthermore, when resources stored in a resource cache server exceed a second predetermined threshold, a least frequently downloaded resource is deleted from the resources.

307: Upon receiving the backup server information, the client (or the mobile terminal) sends a fragmentation request to the original server and the backup server indicated in the backup server information.

The fragmentation request is used to request the server to fragment the resource to be downloaded into a plurality of fragments such that network bandwidth is fully used and a plurality of servers are connected to download the same resource.

It should be noted that one client may correspond to a plurality of servers, including an original server, a proxy download server, and a backup server; and the client may send a fragmentation request to any of these servers connected to the client. These three types of servers are not necessarily available simultaneously, and any form of a combination thereof may be used. For example, when receiving backup server information, the client may send a fragmentation request to the original server and the backup server, and download the resource from the original server and the backup server. When receiving the backup server information, and the proxy download server or the resource cache server also stores the resource, the client may send a fragmentation request to the original server, the backup server, the resource cache server, and the proxy download server, and download the resource from the four types of servers.

308: The client (or the mobile terminal) downloads the resource from the original server and the backup server.

It should be noted that, during the resource downloading process of the client, if a link encounters a failure or the download speed thereon is lower than a third predetermined threshold, the connection between the client and the server may be disabled, and the resource may be downloaded over other connections. Users' selection priorities on a plurality of download servers are listed as follows: the backup server, the original server, and the resource cache server. This greatly reduces the load of the resource cache server.

It should be noted that the third predetermined threshold may be set by those skilled in the art by taking into consideration the average network speed and processing capabilities of the mobile terminal The third predetermined threshold is not associated with the first predetermined threshold or the second predetermined threshold.

Furthermore, when download is interrupted before the resource is completely downloaded, a breakpoint resume transmission request is sent to the original server, the resource cache server, or the backup server corresponding to the backup server information. To be specific, each time a HTTP request is sent starting from the tail position of the previously received resource. This prevents a repeated request from being initiated from the beginning each time. The server corresponding to the server information refers to the backup server corresponding to the backup server information.

During resource downloading of a mobile terminal, when a download request is received from the mobile terminal, server information is provided for the mobile terminal according to local information such that the mobile terminal is capable of downloading a resource or resources from a proxy download server or another server according to the server information. This improves the download speed and bandwidth usage rate of the mobile terminal browser, and enhances the performance of the mobile terminal browser and the performance of the mobile phone.

To improve the performance of a mobile terminal browser, an embodiment of the present invention provides a proxy download server. Referring to FIG. 4, the proxy download server includes:

a receiving module 401, configured to receive a download request from a mobile terminal, and trigger a judging module 402 to judge whether local information includes backup server information of a resource indicated in the download request; and

a sending module 403, configured to, if the local information includes the backup server information of the resource indicated in the download request, send the backup server information to the mobile terminal such that the mobile terminal downloads the resource according to the backup server information.

The judging module 403 includes:

a querying unit, configured to query in a locally stored peer-to-peer resource list and judge whether the locally stored peer-to-peer resource list includes the resource indicated in the download request and the address of the backup server where the resource is stored; where if true, the local information includes the backup server information of the resource indicated in the download request, and otherwise, the local information does not include the backup server information of the resource indicated in the download request.

Referring to FIG. 5, the proxy download server further includes:

a cache module 404, configured to store a resource whose download frequency within a predetermined duration exceeds a first predetermined threshold to a resource cache server, and store a mapping relationship between the resource whose download frequency within the predetermined duration exceeds the first predetermined threshold and the resource cache server.

The proxy download server further includes:

a deleting module 405, configured to, when resources stored in a resource cache server exceed a second predetermined threshold, delete a least frequently downloaded resource from the resources.

The proxy download server provided in this embodiment is based on the same inventive concept as the method embodiments. Therefore, the detailed implementation may refer to the description of the method embodiments of the present invention, which is not described herein any further.

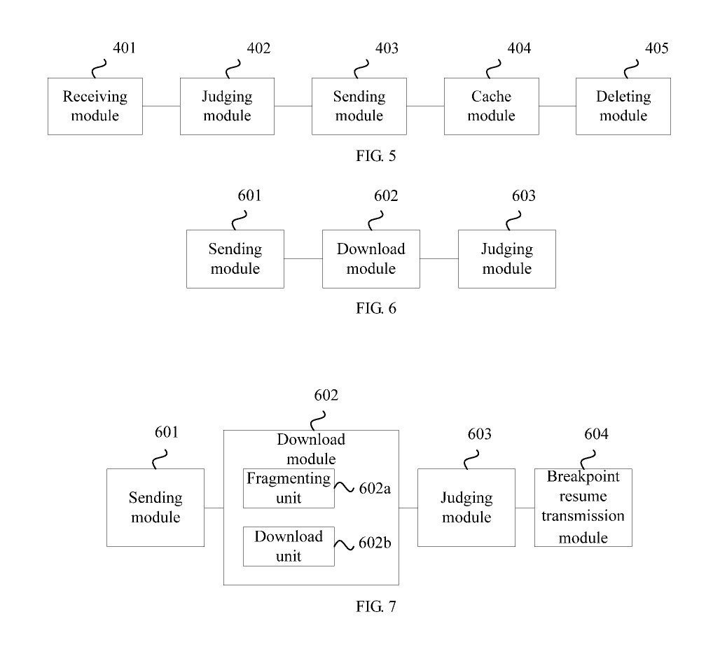

To improve the performance of a mobile terminal browser, an embodiment of the present invention provides a mobile terminal. Referring to FIG. 6, the mobile terminal includes:

a sending module 601, configured to send a download request to a proxy download server; and

a download module 602, configured to receive backup server information from the proxy download server, and download a resource indicated in the download request from a backup server corresponding to the backup server information, where the backup server is a server where the resource indicated in the download request is stored.

The mobile terminal further includes:

a judging module 603, configured to: when no backup server information is received from the proxy download server within the predetermined duration, judge whether a resource cache server stores the resource indicated in the download request; if true, download the resource indicated in the download request from the resource cache server, and otherwise, download the resource indicated in the download request from the original server.

Referring to FIG. 7, the download module 602 includes:

a fragmenting unit 602a, configured to send a fragmentation request to the original server and the backup server corresponding to the backup server information; and

a download unit 602b, configured to download fragments of the resource indicated in the download request from the original server and the backup server corresponding to the backup server information.

The mobile terminal further includes:

a breakpoint resume transmission module 604, configured to, when download is interrupted before resource is completely downloaded, send a breakpoint resume transmission request to the original server, the resource cache server, or the backup server corresponding to the backup server information.

The sending module is further configured to send a download request to an original server, and receive a response packet header from the original server, where the response packet header is of a non-web page file resource type.

The mobile terminal provided in this embodiment is based on the same inventive concept as the method embodiments. Therefore, the detailed implementation may refer to the method embodiments of the present invention, which is not described herein any further.

To improve the performance of a mobile terminal browser, an embodiment of the present invention provides a download system, where the download system includes: a mobile terminal and a proxy download server.

The mobile terminal is configured to send a download request to the proxy download server.

The proxy download server is configured to receive the download request from the mobile terminal, judge whether local information includes backup server information of a resource indicated in the download request, and if the local information includes the backup server information of the resource indicated in the download request, send the backup server information to the mobile terminal

The mobile terminal is further configured to receive backup server information from the proxy download server, and download the resource indicated in the download request from a backup server corresponding to the backup server information, where the backup server is a server where the resource indicated in the download request is stored.

The proxy download server includes:

a judging module, configured to query in a locally stored peer-to-peer resource list and judge whether the locally stored peer-to-peer resource list includes the resource indicated in the download request and the address of the backup server where the resource is stored; where if true, the local information includes the backup server information of the resource indicated in the download request, and otherwise, the local information does not includes the backup server information of the resource indicated in the download request.

Furthermore, the proxy download server further includes:

a cache module, configured to store a resource whose download frequency within a predetermined duration exceeds a first predetermined threshold to a resource cache server, and store a mapping relationship between the resource whose download frequency within the predetermined duration exceeds the first predetermined threshold and the resource cache server.

Furthermore, the proxy download server further includes:

a deleting module, configured to, when resources stored in a resource cache server exceed a second predetermined threshold, delete a least frequently downloaded resources from the resources.

Furthermore, the mobile terminal further includes:

a judging module, configured to: when no backup server information is received from the proxy download server within the predetermined duration, judge whether a resource cache server stores the resource indicated in the download request; if true, download the resource indicated in the download request from the resource cache server, and otherwise, download the resource indicated in the download request from the original server.

Furthermore, the mobile terminal further includes:

a download module, configured to send a fragmentation request to the original server and the backup server corresponding to the backup server information, and download fragments of the resource indicated in the download request from the original server and the backup server corresponding to the backup server information.

Furthermore, the mobile terminal further includes:

a breakpoint resume transmission module, configured to, when download is interrupted before the resource are completely downloaded, send a breakpoint resume transmission request to the original server, the resource cache server, or the backup server corresponding to the backup server information.

Furthermore, the mobile terminal further includes: a sending module, configured to send a download request to an original server, and receive a response packet header from the original server, where the response packet header is of a non-web page file resource type.

According to this embodiment, during resource downloading of a mobile terminal, when a download request is received from the mobile terminal, server information is provided for the mobile terminal according to local information such that the mobile terminal is capable of downloading a resource or resources from a proxy download server or another server according to the server information. This improves the download speed and bandwidth usage rate of the mobile terminal browser, and enhances the performance of the mobile terminal browser and the performance of the mobile terminal

All or part of the technical solutions according to the embodiments of the present invention may be implemented by a program instructing relevant hardware. The program may be stored in a readable storage medium. The storage medium includes various mediums capable of storing program code, such as a read only memory (ROM), a random access memory (RAM), a magnetic disk, or a compact disc read-only memory (CD-ROM).

Described above are merely preferred embodiments of the present invention, but are not intended to limit the present invention. Any modification, equivalent replacement, or improvement made without departing from the spirit and principle of the present invention should fall within the protection scope of the present invention.

1. A download method for a mobile terminal, comprising:
receiving a download request from a mobile terminal, and judging whether local information comprises backup server information of a resource indicated in the download request; and
if the local information comprises the backup server information of the resource indicated in the download request, sending the backup server information to the mobile terminal such that the mobile terminal downloads the resource according to the backup server information.

2. The method according to claim 1, wherein the step of judging whether local information comprises backup server information of a resource indicated in the download request specifically comprises:
querying in a locally stored peer-to-peer resource list and judging whether the list comprises the resource indicated in the download request and the address of the backup server where the resource is stored; if the result is true, the local information comprises the backup server information of the resource indicated in the download request, and otherwise, the local information does not comprise the backup server information of the resource indicated in the download request.

3. The method according to claim 1, further comprising:
storing a resource whose download frequency within a predetermined duration exceeds a first predetermined threshold to a resource cache server, and storing a mapping relationship between the resource whose download frequency within the predetermined duration exceeds the first predetermined threshold and the resource cache server.

4. The method according to claim 1, further comprising:
when resources stored in a resource cache server exceed a second predetermined threshold, deleting a least frequently downloaded resource from the resources.

5. A download method for a mobile terminal, comprising:
sending a download request to a proxy download server; and
receiving backup server information from the proxy download server, and downloading a resource indicated in the download request from a backup server corresponding to the backup server information, wherein the backup server is a server where the resource indicated in the download request is stored.

6. The method according to claim 5, wherein after the step of sending a download request to a proxy download server, the method further comprises:
when no backup server information is received from the proxy download server within the predetermined duration, judging whether a resource cache server stores the resource indicated in the download request; if the result is true, downloading the resource indicated in the download request from the resource cache server, and if otherwise, downloading the resource indicated in the download request from the original server.

7. The method according to claim 6, wherein the downloading resource indicated in the download request from a backup server corresponding to the backup server information specifically comprises:
sending a fragmentation request to the original server and the backup server corresponding to the backup server information, and downloading fragments of the resource indicated in the download request from the original server and the backup server corresponding to the backup server information.

8. The method according to claim 7, further comprising:
when downloading process is interrupted before the resources is completely downloaded, sending a breakpoint resume transmission request to the original server, the resource cache server, or the backup server corresponding to the backup server information.

9. The method according to claim 5, wherein prior to the step of sending a download request to a proxy download server, the method further comprises:
sending a download request to an original server, and receiving a response packet header from the original server, wherein the response packet header is of a non-web page file resource type.

10. A proxy download server, comprising:
a receiving module, configured to receive a download request from a mobile terminal, and trigger a judging module to judge whether local information comprises backup server information of a resource indicated in the download request; and
a sending module, configured to, if the local information comprises the backup server information of the resource indicated in the download request, send the backup server information to the mobile terminal such that the mobile terminal downloads the resource according to the backup server information.

11. The proxy download server according to claim 10, wherein the judging module comprises:
a querying unit, configured to query in a locally stored peer-to-peer resource list and judge whether the locally stored peer-to-peer resource list comprises the resource indicated in the download request and the address of the backup server where the resource is stored; if the result is true, the local information comprises the backup server information of the resource indicated in the download request, and otherwise, the local information does not comprise the backup server information of the resource indicated in the download request.

12. The proxy download server according to claim 10, further comprising:
a cache module, configured to store a resource whose download frequency within a predetermined duration exceeds a first predetermined threshold to a resource cache server, and store a mapping relationship between the resource whose download frequency within the predetermined duration exceeds the first predetermined threshold and the resource cache server.

13. The proxy download server according to claim 10, further comprising:
a deleting module, configured to, when resources stored on a resource cache server exceed a second predetermined threshold, delete a least frequently downloaded resource from the resources.

14. A mobile terminal, comprising:
a sending module, configured to send a download request to a proxy download server; and
a download module, configured to receive backup server information from the proxy download server, and download a resource indicated in the download request from a backup server corresponding to the backup server information, wherein the backup server is a server where the resource indicated in the download request is stored.

15. The mobile terminal according to claim 14, further comprising:
a judging module, configured to: when no backup server information is received from the proxy download server within the predetermined duration, judge whether a resource cache server stores the resource indicated in the download request; if the result is true, download the resource indicated in the download request from the resource cache server, and otherwise, download the resource indicated in the download request from the original server.

16. The mobile terminal according to claim 15, wherein the download module further comprises:
a fragmenting unit, configured to send a fragmentation request to the original server and the backup server corresponding to the backup server information; and
a download unit, configured to download fragments of the resource indicated in the download request from the original server and the backup server corresponding to the backup server information.

17. The mobile terminal according to claim 16, further comprising:
a breakpoint resume transmission module, configured to, when download is interrupted before the resource is completely downloaded, send a breakpoint resume transmission request to the original server, the resource cache server, or the backup server corresponding to the backup server information.

18. The mobile terminal according to claim 14, wherein the sending module is further configured to send a download request to an original server, and receive a response packet header from the original server, wherein the response packet header is of a non-web page file resource type.

19. A download system, comprising: a mobile terminal and a proxy download server; wherein
the mobile terminal is configured to send a download request to the proxy download server;
the proxy download server is configured to receive the download request from the mobile terminal, judge whether local information comprises backup server information of a resource indicated in the download request, and if the local information comprises the backup server information of the resource indicated in the download request, send the backup server information to the mobile terminal; and
the mobile terminal is further configured to receive backup server information from the proxy download server, and download the resource indicated in the download request from a backup server corresponding to the backup server information, wherein the backup server is a server where the resource indicated in the download request is stored.

20. The download system according to claim 19, wherein the proxy download server comprises:
a judging module, configured to query in a locally stored peer-to-peer resource list and judging whether the locally stored peer-to-peer resource list comprises the resource indicated in the download request and the address of the backup server where the resource is stored; if the result is true, the local information comprises the backup server information of the resource indicated in the download request, and otherwise, the local information does not comprise the backup server information of the resource indicated in the download request.

21. The download system according to claim 19, wherein the proxy download server further comprises:
a cache module, configured to store a resource whose download frequency within a predetermined duration exceeds a first predetermined threshold to a resource cache server, and store a mapping relationship between the resource whose download frequency within the predetermined duration exceeds the first predetermined threshold and the resource cache server.

22. The download system according to claim 19, wherein the proxy download server further comprises:
a deleting module, configured to, when resources stored on a resource cache server exceed a second predetermined threshold, delete a least frequently downloaded resource from the resources.

23. The download system according to claim 19, wherein the mobile terminal further comprises:
a judging module, configured to: when no backup server information is received from the proxy download server within the predetermined duration, judge whether a resource cache server stores the resource indicated in the download request; if true, download the resource indicated in the download request from the resource cache server, and otherwise, download the resource indicated in the download request from the original server.

24. The download system according to claim 23, wherein the mobile terminal further comprises:
a download module, configured to send a fragmentation request to the original server and the backup server corresponding to the backup server information, and download fragments of the resource indicated in the download request from the original server and the backup server corresponding to the backup server information.

25. The download system according to claim 24, wherein the mobile terminal further comprises:
a breakpoint resume transmission module, configured to, when download is interrupted before the resource is completely downloaded, send a breakpoint resume transmission request to the original server, the resource cache server, or the backup server corresponding to the backup server information.

26. The download system according to claim 19, wherein the mobile terminal further comprises:
a sending module, configured to send a download request to an original server, and receive a response packet header from the original server, wherein the response packet header is of a non-web page file resource type.
